(19) United States
(12) Patent Application Publication
(10) Pub. No.: US 2025/0196789 A1
(43) Pub. Date: Jun. 19, 2025

(54) WIRELESS CHARGING FEEDBACK AND COMMUNICATION SYSTEM FOR VEHICLES

(71) Applicant: Yank Technologies, Inc., Brooklyn, NY (US)

(72) Inventor: Joshua Aaron YANKOWITZ, Brooklyn, NY (US)

(73) Assignee: Yank Technologies, Inc., Brooklyn, NY (US)

(21) Appl. No.: 18/847,160

(22) PCT Filed: Mar. 13, 2023
(86) PCT No.: PCT/US2023/064247

§ 371 Date: Sep. 13, 2024

Related U.S. Application Data
(60) Provisional application No. 63/269,452, filed on Mar. 16, 2022.

(51) Int. Cl. B60R 16/03; B60R 16/023; H02J 50/12; H02J 50/80; H04W 4/80

(52) U.S. Cl. CPC B60R 16/03; B60R 16/023; H02J 50/80; H04W 4/80; H02J 50/12

(57) ABSTRACT

A vehicular electronic system includes vehicle subsystems, each comprising an electronic control unit and a wireless power receiver subsystem, wherein the electronic control unit is configured to control electrical or electromechanical functions of a corresponding vehicle function, wherein the wireless power subsystem is configured to provide wireless power to the electronic control unit and/or one or more vehicle functions; and a wireless power transmission subsystem configured to wirelessly provide power to the wireless power receiver subsystems.

### CROSS-REFERENCE TO RELATED APPLICATIONS

This application claims priority to and benefit from U.S. Provisional Patent Application No. 63/269,452, entitled “WIRELESS CHARGING FEEDBACK AND COMMUNICATION SYSTEM FOR VEHICLES,” filed on Mar. 16, 2022, which is hereby incorporated by reference in its entirety.

### TECHNICAL FIELD

The present document relates to automotive electronics, and in particular, wireless communication among electronic automotive components in a vehicle.

### BACKGROUND

There has been a steady shift in the automotive industry to replace the traditional mechanical automotive components with electrical and electronic components. The addition of electronic components to an automobile opens up a whole new set of operational challenges and opportunities in the automobile industry.

### BRIEF SUMMARY

Techniques that may be used by embodiments to allow wire-free operation of various intra-vehicular components are disclosed.

In one aspect, disclosed technology provides a vehicular electronic system, comprising: vehicle subsystems, each comprising an electronic control unit and a wireless power receiver subsystem; wherein the electronic control unit is configured to control electrical or electromechanical functions of a corresponding vehicle function, wherein the wireless power receiver subsystem is configured to provide power to the electronic control unit and/or the vehicle function; and a wireless power transmission subsystem configured to wirelessly provide power to the wireless power receiver subsystem.

In another aspect, disclosed technology provides an apparatus for use in a vehicle, comprising: an electronic control unit configured to control operation of a vehicle function, a wireless power receiver configured to provide wireless power to the electronic control unit and/or vehicle function, and an attachment mechanism configured to attach the apparatus for operation within the vehicle, wherein the attachment mechanism is free of wiring to a power or a communication line with the vehicle.

In another aspect, disclosed technology provides a method of operating an apparatus in a vehicle, comprising: configuring an electronic control unit configured to control operation of a vehicle function, operating a wireless power receiver configured to receive wireless power and provide power to operation of the electronic control unit and/or the vehicle function, wherein the apparatus is attached to the vehicle using an attachment mechanism that is free of wiring to a power or a communication line with the vehicle.

These, and other, aspects are disclosed throughout the document.

### BRIEF DESCRIPTION OF THE DRAWINGS

FIG. 1 depicts an example of a wireless charging car seat system.

FIG. 2 is an example of a wireless charging feedback and communication process.

FIG. 3 depicts an example of operational logic used for intra-vehicle electronic component communication.

FIG. 4 shows an example of operational logic with detection circuit.

FIG. 5 is a block diagram of a hardware platform used for implementing various methods disclosed in the present document.

FIG. 6 is a flowchart for an example method disclosed in the present document.

FIG. 7 depicts a vehicular electronic system example.

FIG. 8 depicts an apparatus for use in a vehicle.

### DETAILED DESCRIPTION

The disclosed technology provides systems and methods for wireless charging feedback and communication systems for vehicle car seats and other intra-vehicle equipment to provide greater customization and more features for future vehicles.

As vehicle interiors continue to evolve, there is an increasing need for wireless power transfer systems to eliminate wire harnesses to improve quality control, reduce warranty issues, and include new features. Wireless power transfer can enable features, such as removable seating, interchangeable seat layouts, and the increased ability for rotation and other actuation capabilities.

In order for a wireless power system to be effectively integrated into a vehicle, the system should include an electrical feedback and wireless communication system that can be paired with or as a substitute to existing communication within the vehicle. Without such an arrangement, the usefulness of the wireless charging system is greatly reduced. For example, for a vehicle passenger seat, there are often three primary cables to the vehicle seat: an occupancy detection cable, an airbag initiation cable, and a power line cable. Each cable can include their respective grounds or alternatively have their signal and ground lines routed to the car seat via separate cables. If only the power line cable harness is removed (PWR & GND), then the vehicle still requires the occupancy detection and airbag initiation cables physically connected to the rest of the vehicle. Such a partial wire free arrangement may reduce the purpose of including the wireless charging system or at the very least minimize the full benefit of it. For example, removable seating would still be very difficult to implement along with rotation and other additional actuation features because of the mechanical connections to the other harness cables. In order to establish a complete wireless connection to vehicle parts, such as car seats, we are proposing a new communication and feedback system for the wireless charging system.

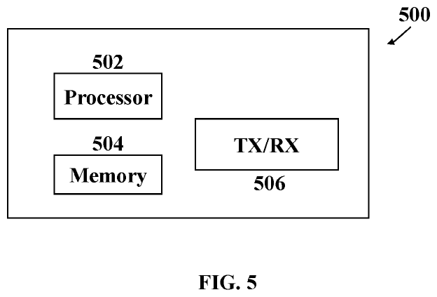

Normally, the electronic control unit (ECU) in the car seat communicates with other electronic control units in the vehicle via a CAN or LIN bus communication system. This is also true for other ECU locations, such as ECUs in doors and instrument panels. This system allows multiple ECUs throughout the vehicle to communicate to one another in real-time. Therefore, the integration of a wireless communication system with the wireless charging system is advantageous for practical use. The ECU may include a processor, a memory and a communication interface, e.g., as disclosed in FIG. 5.

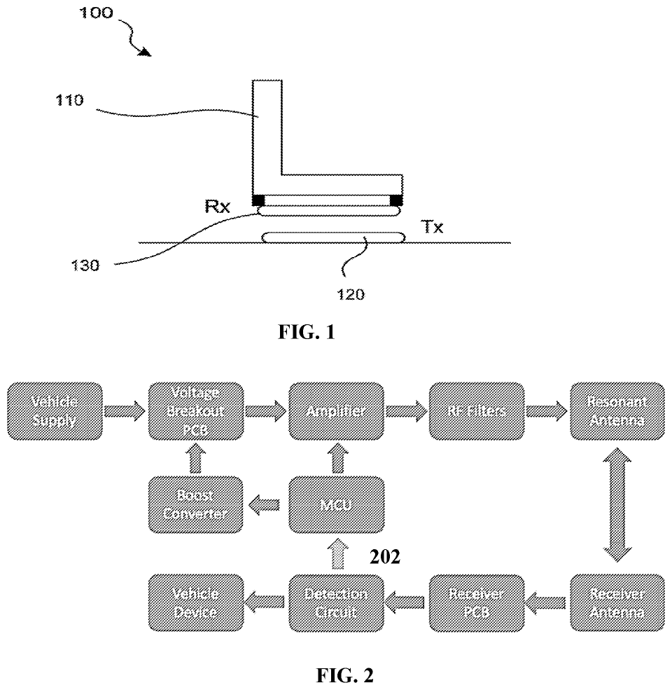

FIG. 1 is a representative illustration of a wireless charging vehicle seat system 100. In system 100, a single transmitter antenna (Tx) 120 is placed on or in the floor of the vehicle and a receiver (Rx) 130 is embedded into the vehicle seat 110. The transmitter 120 consists of an amplifier, which converts a DC signal to an amplified AC signal which is driven to a resonating antenna at radio frequencies. This antenna then wirelessly couples to a receiver antenna in receiver 130 inside the vehicle seat at approximately the same resonant frequency. The amplifier drives a signal to resonant capacitors which substantially excide one or more transmitter antennas into resonance. The amplifiers operating frequency is approximately equal to the resonant frequency of the antenna or antennas. For exemplary embodiments, please see PCT Patent Application No. PCT/US2021/021121, entitled “Automotive Car Seat Wireless Charging System,” which is hereby incorporated by reference in its entirety.

Receiver 130 includes an alternating-current to direct-current (AC/DC) converter and a voltage regulator for the voltage inputs of various electronic systems in the seat, for example, the fans, sensors, actuators, and motors. This allows the vehicle OEM to potentially eliminate portions of the wiring harness in the vehicle, and include new features, such as removable vehicle seats for a wider range of vehicle interior layouts, and rotating seats. The transmitter antenna and the receiver antenna can be planar antennas, electrodeposited antennas electrodeposited directly onto a vehicle seat part or floor panel, or three-dimensional antennas. For further details, please see PCT Patent Application No. PCT/US2021/021121, entitled “Automotive Car Seat Wireless Charging System,” which is hereby incorporated by reference in its entirety.

In this wireless charging vehicle seat example, a wireless charging feedback and communication system can be developed to improve system efficiency and practical implementation.

In FIG. 2, there is an example flow chart of the proposed wireless charging feedback and communication system. In the transmitter, the wire harness supply line is electrically connected to a voltage breakout board. In this voltage breakout board, there is a step-down converter for the amplifier digital logic and a boost converter for the amplifier input. The step-down converter for the amplifier digital logic can be a buck converter or sepic (single end primary inductor) converter. Furthermore, the voltage breakout board can have reverse-polarity protection, EMI filters, fuse protection, and other forms of electromagnetic interference EMI, short circuit, and reverse-polarity protection circuitry.

The power amplifier can be a switching amplifier, such as a series or parallel resonant or off-resonant Class D or Class E amplifier. Additionally, the power amplifier can be single-ended or differential. The power amplifier can comprise an isolated switching amplifier topology. In a parallel-tuned power amplifier, the load network and matching network are tuned such that the transmitter antenna is in parallel rather than in series to the resonant capacitor with the load network of the amplifier also tuned at the same resonant frequency. That is, the entire power amplifier network operates completely in resonance rather than using an off-resonant load network. This way, the voltage across the transmitter is maximized and harmonics are reduced. By maximizing the voltage, there is higher oscillating current flowing through the transmitter antenna or a stronger magnetic field to be coupled with the receiver, especially in a loose coupling resonant inductive system, such as when the transmitter and receiver are physically far apart. In some embodiments, a transformer can also be included to further increase the oscillating voltage across the transmitter antenna and thereby further improve the flux linkage and power delivery between the transmitter and receiver. Additionally, the parallel resonant power amplifier is better protected from movements or changes in the position of the receiver or capacitive and inductive reflections from the surrounding environment that could cause a substantial change in the efficiency of the power amplifier. For further details, please see PCT Patent Application No. PCT/US2021/021121, entitled “Automotive Car Seat Wireless Charging System,” which is hereby incorporated by reference in its entirety.

The power amplifier can then be electrically coupled to RF filters, such as bandpass filters, to attenuate undesirable harmonics and spurious signals. The signal then couples with antenna(s) tuned with resonant capacitors.

The receiver antenna(s) are excited with capacitors to substantially resonate and capture the flux from the transmitter antenna(s). This signal is then electrically connected to an AC/DC converter and regulator for various voltage levels depending on the application, but typically 12V for use within the vehicle.

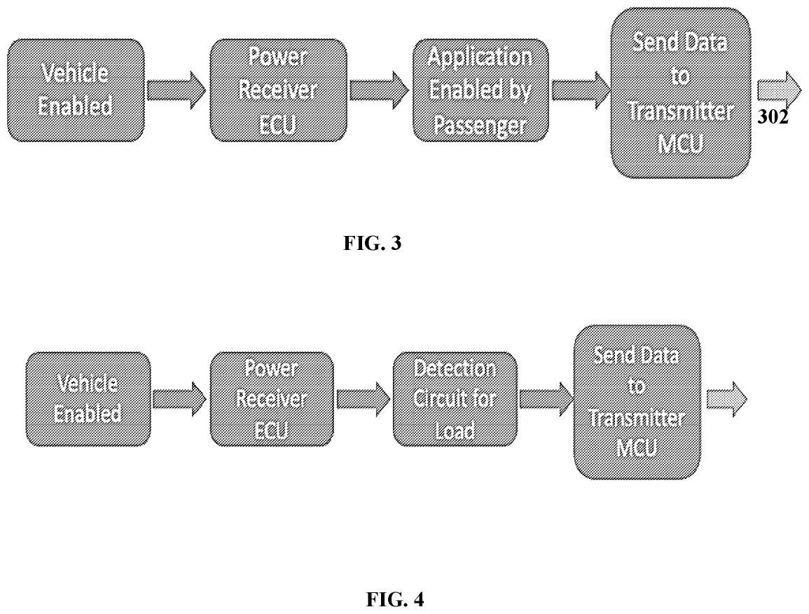

FIG. 3 illustrates example operation logic of the system described in FIG. 2. When the vehicle is enabled, the wireless power system will charge the ECUs for the receiver, which have a typically low power consumption of approximately several watts per ECU. For example, this can be an ECU in a car seat or door. In a vehicle, there are a plurality of ECUs that communicate and share information with one another typically via a CAN bus system in real-time. In order to appropriately respond and share information with other ECUs, it's important that there is a default charging setting is to ensure that the ECUs have the power to communicate with each other in the vehicle. This is especially important for the communication of safety functions, such as occupancy detection or airbag detection. In this instance, “enabled” can be defined as always powering the ECU, powering the ECU when the vehicle is unlocked, or powering the ECU only when the ignition for the vehicle is enabled.

There are multiple functions within vehicle products that require different amounts of power. For example, car seat fans can consume 20 Ws to 30 Ws, while car seat heaters can consume more than 80 Ws. Meanwhile, there are also differences in steady state power and peak power consumption for applications like actuators.

Therefore, there are many instances in which the power consumption requirements vary greatly depending on whether the passenger is enabling any functions and can vary greatly depending on the specific function being used. For example, it will be highly inefficient for the amplifier to output more than 80 Ws, so it is capable of powering the heaters when the fans are only used. Therefore, a dynamic output power system should be integrated to improve system efficiency. With the proliferation of electric vehicles, the system efficiency of a wireless charging system being integrated within vehicle interiors will become increasingly important.

The ECU(s) being wirelessly powered can be configured with a wireless communication system, such as a CAN wireless or LIN wireless system, to encrypt and communicate with the other ECUs in the vehicle. In addition to the normal communication with other ECUs in the vehicle, the wirelessly powered ECU in the receiver can send a wireless signal to the MCU in the transmitter to inform it of what application, if any, is currently being enabled. This wireless signal is highlighted as arrows 202 and 302 in FIG. 2 and in FIG. 3. Based on the power requirement for the application, the MCU can change the voltage output of the boost converter, such as changing the value of digital potentiometer of the resistor divider for the converter, to in turn change the output power of the amplifier for differing applications. These boost converter voltage outputs and resistance values for a digital potentiometer can be pre-determined based on the minimum output power necessary to charge each car application. Furthermore, the MCU can also be pre-programmed to differ the output of the boost converter for the peak versus steady state power consumption to maintain higher overall efficiency. For example, a car seat actuator may have a peak instantaneous power consumption of ˜50 Ws for a few microseconds or even a few seconds, while the steady state power consumption may be ˜40 Ws. After the receiver informs the MCU of the transmitter that the actuators are being enabled, the MCU can vary the output of the boost converter for not only the actuator application, but also change the output over time by having a higher output for the peak instantaneous power and then reduce the output power for the steady-state condition to improve operational efficiency.

The receiver ECU(s) can directly communicate with the transmitter unit or a detection circuit can independently measure the voltage, current, and/or power consumption of the receiver load and send a wireless signal to the transmitter unit as shown in the operation logic in FIG. 4. This wireless signal can be potentially on the same channel as the ECU communication to have an extra layer of redundancy for increased safe operation or it can be on independent channels, such as a Bluetooth communication protocol for the receiver to inform the transmitter unit on the power application and a CAN wireless communication protocol for the ECUs to communicate throughout the vehicle.

Furthermore, if a separate detection circuit is implemented, more detailed information can be sent to the transmitter to determine the boost converter output to the amplifier. Rather than the application being used by the passenger, the voltage, current, and power being drawn can determine how an MCU changes a digital potentiometer to change the output voltage of the boost converter to the amplifier. For example, when the power being drawn increases from the load and the voltage drops below a certain threshold, the transmitter can readily increase the output power until the receiver detection circuit measures a voltage above a certain minimum threshold. This can potentially be more efficient than changing the output based on the application being used because it allows the transmitter to adjust the necessary output in more refined steps and for more precise power requirements.

To summarize, this feedback and wireless communication system allows increased features and functions to be included in next-generation wireless charging systems at higher system efficiencies.

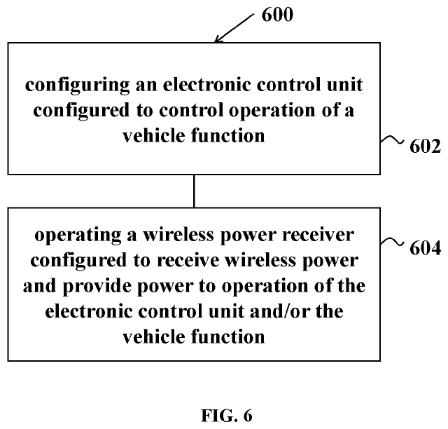

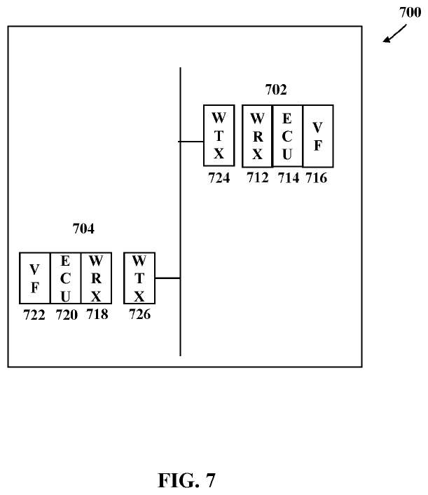

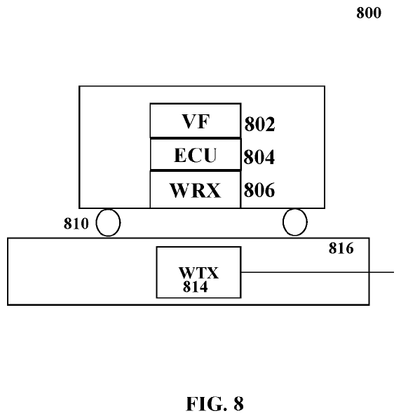

The following technical solutions may be preferably incorporated within certain embodiments.
1. A vehicular electronic system (e.g., system 700 depicted in FIG. 7), comprising: vehicle subsystems (702, 704), each comprising an electronic control unit (714, 720) and a wireless power receiver subsystem (712, 718); wherein the electronic control unit is configured to control electrical or electromechanical functions of the vehicle, wherein the wireless power subsystem (712, 718) is configured to provide power, which is wirelessly obtained from the wireless power transmitter (724, 726), to the electronic control unit and/or the vehicle function (716, 722); and a wireless power transmission subsystem (724, 726) configured to wirelessly provide power to the wireless power receiver subsystems.
2. The vehicular electronic system of solution 1, wherein the wireless power transmission subsystem and the wireless power receiver subsystem or an electronic control unit are configured to perform wireless communication with one another.
3. The vehicular electronic system of solution 2, wherein the wireless communication is used to control operation of wireless power transfer between the wireless power transmission subsystem and the wireless power receiver subsystem.
4. The vehicular electronic system of solution 2, wherein the wireless communication carries control area network (CAN) or local interconnect network (LIN) messages related to operation of the vehicle subsystems.
5. The vehicular electronic system of any of solutions 1-4, wherein the vehicle subsystems are configured to communicate in absence of power and/or communication harness lines. Due to this advantageous property, the vehicle subsystems may be easier to move, rotate, or remove from the vehicle to achieve a flexible configuration of the vehicle, perform repair and maintenance without additional complication of detaching/attaching wires or cables, reduced warranty or labor costs, and so on.
6. The vehicular electronic system of any of solutions 1-5, wherein the wireless power receiver subsystem or an electronic control unit is configured to communicate a vehicle application function being used by a passenger, a voltage, a current, or an amount of power being drawn by the vehicle application function to the wireless power transmission subsystem configured to provide wireless power to the wireless power receiver subsystem. Furthermore, the transmitter unit can communicate this information with other transmitter units in the system, such as 724 and 726, and other ECUs in various areas in the vehicle.
7. The vehicular electronic system of any of solutions 1-6, wherein the vehicle subsystems include a car seat function, a door function, a window function, a motor function, an airbag function, a seat occupancy function, ambient lighting, or an audio function. For example, car seat functions may include seat warming, monitoring temperature of the seat, adjusting seat back inclination, moving seat base back and forth, seat rotation, and so on. For example, a window function may include rolling up or down the window or adjusting window tint. For example, airbag function may include monitoring operational status of the airbag or causing the airbag to deploy in case of an emergency. The seat occupancy function may include, for example, using a weight sensor, a coupling measurement, or a contact sensor to determine whether a passenger is seating such that a seat belt sign may be prompted. An audio function may include, for example volume adjustment, channel changes or adjusting audio balance inside the vehicle.
8. The vehicular electronic system of any of solutions 2-4, wherein the wireless communication is performed using wireless power signals transferred between the wireless power transmission subsystem and wireless power receiver subsystem. For example, in some embodiments, backscatter communication may be used. In some embodiments, frequency or amplitude modulation may be used.
9. The vehicular electronic system of any of solutions 2-4, wherein the wireless communication is performed using Wi-Fi, Bluetooth, or a wireless CAN or LIN bus communication system.
10. An apparatus for use in a vehicle (e.g., apparatus 800 depicted in FIG. 8), comprising: an electronic control unit (804) configured to control operation of a vehicle function (802), a wireless power receiver (806) configured to provide power to the electronic control unit and/or vehicle function (802), and an attachment mechanism (810) configured to attach the apparatus for operation within the vehicle (816), wherein the attachment mechanism is free of wiring that couples the apparatus to a power or communication line with the vehicle. The ECU 804 may be implemented as described with respect to FIG. 5. For example, the attachment mechanism may be used to secure the apparatus to the vehicle and may comprise a bracket, a bolt, a screw mechanism, or other fastening mechanical approaches. Furthermore, the attachment mechanism may be for either bolting, fastening, or securing the apparatus to the vehicle part, such as mounting the apparatus to the bottom of the car seat, or it may refer to the mounting of the vehicle part and the apparatus to the vehicle body, such as bolting the car seat to the car seat rails of the vehicle. In either embodiment, the attachment mechanism is free of a portion of the wire harness that couples the apparatus to a power or communication line within the vehicle.
11. The apparatus of solution 10, wherein the electronic control unit is configured to perform wireless communication with other electronic control units in the vehicle.
12. The apparatus of solution 11, wherein the wireless communication is used to control operation of wireless power transfer between a wireless power transmission subsystem (814) and a wireless power receiver subsystem (806).
13. The apparatus of solution 11, wherein the wireless communication carries control area network (CAN) or local interconnect network (LIN) messages related to operation of the electronic control unit.
14. The apparatus of any of solutions 10-13, wherein the apparatus controls a car seat function, a door function, a window function, a motor function, an airbag function, a seat occupancy function, an ambient lighting function, or an audio function, as disclosed in the present document.
15. The apparatus of any of solutions 11-12, wherein the wireless communication is performed at least partly by modulating power signals of the wireless power transmission subsystem, as disclosed in the present document.
16. The apparatus of any of solutions 11-13 and 15, wherein the apparatus further includes a wireless transceiver, and wherein the wireless communication is performed using the wireless transceiver.
17. The apparatus of solution 16, wherein the wireless communication uses Wi-Fi, Bluetooth, or a wireless CAN or LIN bus communication system.
18. The apparatus of any of solutions 10-17, further including a wireless power receiver that comprises a receiver antenna, a matching network, an AC/DC converter, and a regulator. For example, the matching network may be used to match the impedance of the receiving antenna with the subsequent circuit that drives power into a battery, the ECU, or a vehicle function. The AC/DC converter (alternating current/direct current) may be used to generate a rectified voltage used for battery charging, for ECU powering, and/or vehicle function powering. A regulator may be used to ensure that the charge voltage or current stays within a range and/or does not shoot up beyond a safety limit. This can include a voltage regulator, current limiter, sepic converter, flyback converter, buck converter, boost converter, and other kinds of DC-DC converters.
19. A method of operating an apparatus in a vehicle (e.g., method 600 depicted in FIG. 6), comprising: configuring (602) an electronic control unit configured to control operation of a vehicle function, and operating (604) a wireless power receiver configured to receive wireless power and provide power to operation of the electronic control unit and/or the vehicle function. The apparatus is attached to the vehicle using an attachment mechanism that is free of wiring to a power or communication line within the vehicle couples the apparatus with the vehicle body or a vehicle part.
20. The method of solution 19, wherein the wireless power receiver transmits a signal to a wireless power transmitter, and wherein a microcontroller unit (MCU) in the wireless power transmitter adjusts an output of a boost converter to an amplifier in response to a signal received by the wireless power receiver.
21. The method of any of solutions 20, further including the wireless power receiver or an electronic control unit communicating an application function being used by a passenger, a voltage, a current, or an amount of power being drawn by the application function to the wireless power transmitter.
22. The method of solution 21, wherein the application function includes a car seat function, a door function, a window function, a motor function, an airbag function, a seat occupancy function, an ambient lighting function, or an audio function.
23. The method of any of solutions 19-22, wherein the wireless power receiver communicates using Wi-Fi, Bluetooth, or a wireless CAN or LIN bus communication system.

FIG. 5 depicts an example of a hardware platform 500 that may be used for implementing the ECU described herein. The hardware platform includes a processor 502, an optional memory 504 and a transmission/reception circuit 506. The processor 502 may be configured to execute program code for controlling various operational aspects of the ECU. The memory 504 may be optionally omitted in some embodiments by incorporating storage functionality into the processor 502. The TX/RX circuit 506 may include the wireless power receiver described in the present document and further may include other communication functionalities such as Wi-Fi, Bluetooth, near field communication (NFC) and the like.

In the solutions described herein, more than one vehicle function may be powered simultaneously by the wireless power transfer from the transmitter to the receiver. For example, the user can be using the car seat heaters while moving the car seat actuators.

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

These and other changes can be made to the invention in light of the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A vehicular electronic system, comprising:
vehicle subsystems, each comprising an electronic control unit and a wireless power receiver subsystem;
wherein the electronic control unit is configured to control electrical or electromechanical functions of a corresponding vehicle function,
wherein the wireless power receiver subsystem is configured to provide power to the electronic control unit and/or the corresponding vehicle function; and
a wireless power transmission subsystem configured to wirelessly provide power to the wireless power receiver subsystem.

2. The vehicular electronic system of claim 1, wherein the wireless power transmission subsystem and the wireless power receiver subsystem or the electronic control unit are configured to perform wireless communication with one another.

3. The vehicular electronic system of claim 2, wherein the wireless communication is used to control operation of wireless power transfer between the wireless power transmission subsystem and the wireless power receiver subsystem.

4. The vehicular electronic system of claim 2, wherein the wireless communication carries control area network (CAN) or local interconnect network (LIN) messages related to operation of the vehicle subsystems.

5. The vehicular electronic system of claim 1, wherein the vehicle subsystems are configured to communicate in absence of cable harnesses.

6. The vehicular electronic system of claim 1, wherein the wireless power receiver subsystem is configured to communicate an application function being used by a passenger, a voltage, a current, or an amount of power being drawn by the application function to the wireless power transmission subsystem configured to provide wireless power to the wireless power receiver subsystem.

7. The vehicular electronic system of claim 1, wherein the vehicle subsystems include a car seat function, a door function, a window function, a motor function, an airbag function, a seat occupancy function, an ambient lighting function, a heater function, or an audio function.

8. The vehicular electronic system of claim 2, wherein the wireless communication is performed using wireless power signals transferred between the wireless power transmission subsystem and the wireless power receiver subsystem, wherein the wireless communication is performed using Wi-Fi, Bluetooth, or a wireless CAN or LIN bus communication system.

9. (canceled)

10. An apparatus for use in a vehicle, comprising:
an electronic control unit configured to control operation of a vehicle function,
a wireless power receiver configured to provide wireless power to the electronic control unit and/or the vehicle function, and
an attachment mechanism configured to attach the apparatus for operation within the vehicle, wherein the attachment mechanism is free of wiring that couples the apparatus to a power or a communication line with the vehicle.

11. The apparatus of claim 10, wherein the electronic control unit is configured to perform wireless communication with other electronic control units in the vehicle.

12. The apparatus of claim 11, wherein the wireless communication is used to control an operation of wireless power transfer between a wireless power transmission subsystem and a wireless power receiver subsystem.

13. The apparatus of claim 11, wherein the wireless communication carries control area network (CAN) or local interconnect network (LIN) messages related to operation of the electronic control unit.

14. The apparatus of claim 10, wherein the apparatus controls a car seat function, a door function, a window function, a motor function, an airbag function, a seat occupancy function, an ambient lighting function, a heater function, or an audio function.

15. The apparatus of claim 12, wherein the wireless communication is performed at least partly by modulating power signals of the wireless power transmission subsystem.

16. The apparatus of claim 11, wherein the apparatus further includes a wireless transceiver, and wherein the wireless communication is performed using the wireless transceiver, wherein the wireless communication uses Wi-Fi, Bluetooth, or a wireless CAN or LIN bus communication system.

17. (canceled)

18. The apparatus of claim 10, further including a wireless power receiver that comprises a receiver antenna, a matching network, an AC/DC converter, and a regulator.

19. A method of operating an apparatus in a vehicle, comprising:
configuring an electronic control unit configured to control operation of the apparatus; and
operating a wireless power receiver configured to receive wireless power and provide power to operation of the electronic control unit and/or one or many vehicle functions,
wherein the apparatus is attached to the vehicle using an attachment mechanism that is free of wiring to a power or a communication line within the vehicle.

20. The method of claim 19, wherein the wireless power receiver transmits a signal to a wireless power transmitter, and wherein a microcontroller unit (MCU) in the wireless power transmitter adjusts an output of a DC-DC converter to an amplifier in response to a signal received by the wireless power receiver.

21. The method of claim 20, further including the wireless power receiver communicating an application function being used by a passenger, a voltage, a current, or an amount of power being drawn by the application function to the wireless power transmitter, wherein the application function includes a car seat function, a door function, a window function, a motor function, an airbag function, a seat occupancy function, an ambient lighting function, a heater function, or an audio function.

22. (canceled)

23. The method of claim 19, wherein the wireless power receiver or an electronic control unit communicates using Wi-Fi, Bluetooth, or a wireless CAN or LIN bus communication system.
